(19) United States
(12) Patent Application Publication
(10) Pub. No.: US 2022/0411074 A1
(43) Pub. Date: Dec. 29, 2022

(54) AIR SUPPLY SYSTEM FOR A PNEUMATIC DE-ICING ASSEMBLY OF AN AIRCRAFT, AND AIRCRAFT COMPRISING SUCH AN AIR SUPPLY SYSTEM

(71) Applicants: Airbus Operations SAS, TOULOUSE (FR); Airbus Operations GmbH, HAMBURG (DE)

(72) Inventors: Florent HUET, TOULOUSE (FR); Thomas JOSSET, TOULOUSE (FR); Holger BAMMANN, HAMBURG (DE); Marion GOURGUES, TOULOUSE (FR)

(21) Appl. No.: 17/849,915

(22) Filed: Jun. 27, 2022

(30) Foreign Application Priority Data
Jun. 29, 2021 (FR) 2106968

(51) Int. Cl. B64D 13/06; B64D 27/24

(52) U.S. Cl. CPC B64D 13/06; B64D 27/24; B64D 2013/0607

(57) ABSTRACT

An air supply system for a pneumatic de-icing assembly for de-icing surfaces of an aircraft, the aircraft comprising an air-conditioning system supplied by at least one first air compressor connected to a device for drawing in air outside the aircraft, the pneumatic de-icing assembly comprising an air supply inlet connected to an outlet of the first air compressor or to an outlet of the air-conditioning system. Thus, it is possible to supply air to a pneumatic de-icing system of an airplane equipped with electric motors or of what is referred to as “bleedless” type.

### CROSS-REFERENCES TO RELATED APPLICATIONS

This application claims the benefit of the French patent application No. 2106968 filed on Jun. 29, 2021, the entire disclosures of which are incorporated herein by way of reference.

### FIELD OF THE INVENTION

The present invention relates to de-icing systems for de-icing surfaces of aircraft, and more particularly to the supply of air to pneumatic de-icing systems for aircraft. The invention also relates to an aircraft comprising a pneumatic de-icing system.

### BACKGROUND OF THE INVENTION

There are several de-icing methods for removing ice and frost that has accumulated on an aircraft. These methods may differ depending on whether the aircraft is on the ground or in flight. Certain methods use inflatable boots (or inflating boots) which are arranged on the exterior surfaces of the aircraft, in particular on the leading edges and the stabilizers of the aircraft. These inflatable boots generally comprise a plurality of inflatable chambers which are inflated or deflated successively, alternately or at the same time, if necessary, in order to break up the accumulated ice. These systems for de-icing by means of inflatable boots are generally supplied with pressurized air drawn from the engines of the aircraft in order to inflate or deflate boots arranged on the surfaces of the aircraft. Inflation can be effected by direct application of a pressurized air flow, and deflation can be effected via the creation of a suction flow from a pressurized air flow. However, certain aircraft are propelled by electric motors which are unable to provide the pressurized air required for a pneumatic de-icing system. Furthermore, it can sometimes be advantageous to not extract air from the engines of an airplane, for example in order to save fuel by reducing the mass of the airplane by removing elements associated with the use of air from the engines.

There is therefore a need for a means of providing air for a pneumatic de-icing system of an aircraft propelled by one or more electric motors or configured so as to not bleed engine air.

### SUMMARY OF THE INVENTION

A particular aim of the present invention is to supply a pneumatic de-icing assembly of an aircraft from a source other than its engine or engines.

To this end, one subject of the invention is an air supply system for a pneumatic de-icing assembly for de-icing surfaces of an aircraft, the aircraft comprising an air-conditioning system of the ECS type which is supplied by at least one first supply compressor connected to a device for drawing in air outside the aircraft via at least one air duct, the air supply system comprising an air supply inlet of the pneumatic de-icing assembly, the air supply inlet being connected to an outlet of the at least one first supply compressor or to an outlet of the air-conditioning system.

Advantageously, “sharing” with the air-conditioning system makes it possible to limit the energy required for supplying air at a sufficient pressure for the operations of the pneumatic de-icing assembly for de-icing surfaces of the aircraft.

The air supply system according to the invention, which is configured to supply a pneumatic de-icing assembly for de-icing surfaces of aircraft, may also have the following features, considered alone or in combination:
The air supply inlet of the de-icing assembly is connected to an outlet of the at least one first supply compressor, and a second compressor, referred to as “additional compressor”, is configured and can be used to supply air to the air supply inlet of the pneumatic de-icing assembly from the outlet of the first supply compressor.
The air supply inlet of the de-icing assembly is connected to an outlet of the air-conditioning system, and a second compressor, referred to as “additional compressor”, is configured and can be used to supply air to the air supply inlet of the pneumatic de-icing assembly from the outlet of the air-conditioning system.
The air supply system comprises a second supply compressor connected to a device for drawing in air outside the aircraft via at least one air duct configured to supply at least the air-conditioning system, and the inlet of the pneumatic de-icing assembly is further connected to an outlet of the second supply compressor.

Another subject of the invention is a de-icing method for de-icing surfaces of an aircraft, executed (implemented) in an air supply system for a pneumatic de-icing assembly for de-icing surfaces of the aircraft, the aircraft comprising an air-conditioning system of the ECS type, the air-conditioning system comprising at least one supply compressor connected to a device for drawing in air outside the aircraft via at least one air duct, the air supply system being arranged such that an air supply inlet of the pneumatic de-icing assembly is connected to an outlet of the at least one supply compressor or to an outlet of the air-conditioning system, the pneumatic de-icing method comprising the following steps:
(i) drawing in air at the outlet of a supply compressor configured to supply an air-conditioning system, or at the outlet of the air-conditioning system,
(ii) inflating or deflating the inflating boot using all or some of the drawn-in air.

According to one embodiment of the invention, the pneumatic de-icing method further comprises, between steps (i) and (ii):
compressing the air drawn in in step (i) by means of an additional compressor.

Another subject of the invention is an aircraft comprising an air supply system as described above.

According to one embodiment, the aircraft is configured to be propelled solely by electric motors.

Another subject of the invention is an aircraft part comprising a pneumatic de-icing system and an air-conditioning system as described above, or an aircraft comprising a pneumatic de-icing system and an air-conditioning system as described above.

### BRIEF DESCRIPTION OF THE DRAWINGS

The features of the invention that were mentioned above, along with others, will become more clearly apparent on reading the following description of at least one example of embodiment, the description being given with reference to the appended drawings, in which:

FIG. 1 schematically illustrates an air supply system architecture of an aircraft pneumatic de-icing assembly, according to a first embodiment;

FIG. 2 schematically illustrates the air supply system architecture of a de-icing assembly already depicted in FIG. 1, according to a variant of the first embodiment;

FIG. 3 schematically illustrates the air supply system architecture of an aircraft pneumatic de-icing assembly, according to a second embodiment;

FIG. 4 schematically illustrates the air supply system architecture of a de-icing assembly already depicted in FIG. 3, according to a variant of the second embodiment; and

FIG. 5 illustrates an aircraft comprising an air supply system of a de-icing assembly as depicted in one of FIG. 1, FIG. 2, FIG. 3 and FIG. 4.

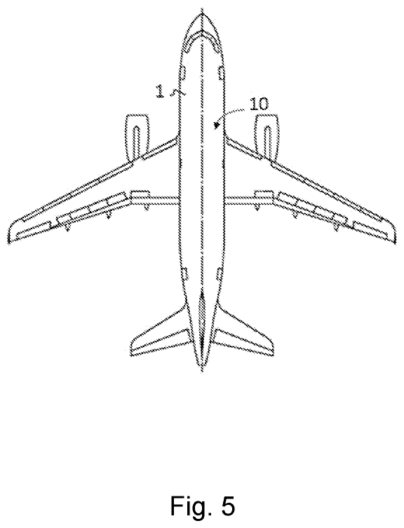

### DETAILED DESCRIPTION OF THE PREFERRED EMBODIMENTS

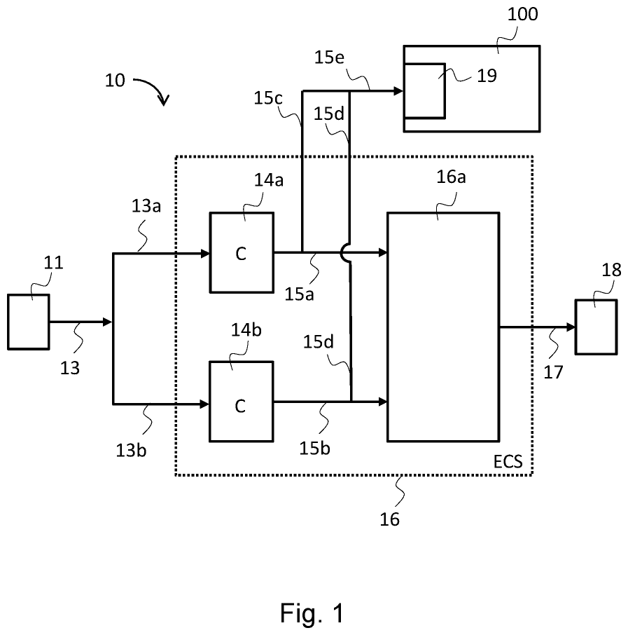

FIG. 1 schematically depicts an air supply system 10 for supplying air to a pneumatic de-icing assembly 100 of an aircraft, according to a first embodiment. All the elements schematically depicted in FIG. 1 are therefore arranged in the aircraft which comprises the pneumatic de-icing assembly 100. The pneumatic de-icing assembly 100 comprises an air inlet 19 connected to an air duct 15e. According to variants, the pneumatic de-icing assembly 100 comprises a plurality of air inlets that are similar to the air inlet 19 and that are connected to the air duct 15e.

The aircraft comprising the pneumatic de-icing system 100 further comprises an air-conditioning system ECS 16, of the ECS type, configured, in particular to supply pressurized air, the temperature of which is controlled, into the passenger cabin and into the cockpit of the aircraft. The air-conditioning system ECS 16 is usually denoted ECS (Environmental Control System). To this end, air outside the aircraft is drawn in via an exterior air inlet 11, also called a “scoop” 11, and is then conducted in at least one air duct 13 and 13a to at least one (air) supply compressor 14a which constitutes a first compressor stage of the air-conditioning system ECS 16. Such a first compressor stage of an air-conditioning system is also denoted “first compressor” for conditioning air. In the remainder of the present description, such a compressor will equally be denoted “first compressor”, “supply compressor”, “air supply compressor” or “first supply compressor”. According to a particular embodiment, use is made of two first supply compressors 14a and 14b, which are respectively connected to two inlets of a sub-assembly 16a of the air-conditioning system ECS 16. Thus, if an operating fault occurs for either one of the two first supply compressors 14a and 14b, the other one of these supply compressors can be configured to compensate for this fault, such that the air-conditioning system ECS 16 maintains a performance level suitable for flight conditions. The respective outlets of the supply compressors 14a and 14b are respectively connected to inlets of the sub-assembly 16a of the air-conditioning system ECS 16 via air ducts 15a and 15b. According to one variant, one and the same air inlet supplies both supply compressors 14a and 14b.

According to another variant, a single supply compressor 14a or 14b may be implemented and may then supply compressed air to an inlet of the sub-assembly 16a of the air-conditioning system ECS 16 from outside air drawn in via the scoop 11 and conveyed via a duct 13 and 13a or 13 and 13b (depending on whether compressor 14a or 14b is implemented). The air-conditioning system ECS 16 comprises an air outlet 18 allowing air to be extracted from the volumes of the aircraft that are supplied with conditioned air. The air to be extracted is conveyed to the air outlet 18 via an air duct 17.

The air-conditioning system ECS 16 is an air-conditioning system that is conventionally used in an aircraft and its internal architecture is not described in detail in this instance insofar as it is not useful for the comprehension of the invention.

Cleverly and advantageously, the air duct 15e configured for conveying air to the air inlet 19 of the pneumatic de-icing system 100 is connected to the outlets of the first compressors 14a and 14b of the compression stage which is inherently assigned to the air-conditioning system ECS 16. In other words, the air duct 15e that conveys air to the pneumatic de-icing assembly 100 is connected to the air ducts 15a and 15b via air ducts 15c and 15d. Thus, the air used at the inlet of the pneumatic de-icing assembly 100 is extracted after the first compressor stage of the air-conditioning system ECS 16. According to this embodiment, the drawing-in of air effected requires more air to be drawn in and pressurized than in a configuration according to the prior art. The scoop 11 and the first compressor stage comprising the supply compressor 14a and/or the supply compressor 14b have to be adapted.

Drawing in air at the outlet of the first compression stage, that is to say, at the outlet of at least one of the supply compressors 14a and 14b, does not necessarily mean that the air is drawn in directly at the outlet of the supply compressor. The air may be drawn in at an element connected to the outlet of the supply compressor, such as a duct, a bypass, or any other element of the supply system that is situated between an outlet of the first compression stage (of a first supply compressor) and an inlet of the sub-assembly 16a of the air-conditioning system ECS 16. According to one embodiment, the sub-assembly 16a of the air-conditioning system ECS 16 comprises all the air-conditioning installations for the passenger cabin, the cockpit and the holds of the aircraft. In other words, and according to this first embodiment, the air drawn in for the purpose of supplying air to the pneumatic de-icing assembly 100 is drawn in downstream of the first compression stage and upstream of the air-conditioning sub-assembly 16a. The term “downstream” in this case denoting a relative positioning towards the air outlet 18, and the term “upstream” in this case denoting a relative positioning towards the air inlet (or scoop) 11.

If the pressure of the drawn-in air is not sufficient for the supply of the pneumatic de-icing system 100, an additional compressor (not depicted in FIG. 1) is added.

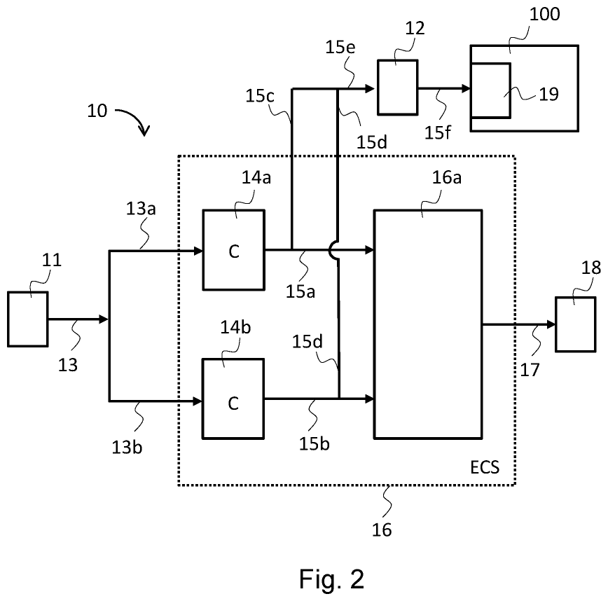

FIG. 2 depicts a variant of the first embodiment comprising an additional compressor 12, the inlet of which is connected to the air duct 15e and the outlet of which is connected to the air inlet 19 of the pneumatic de-icing assembly 100 via an air duct 15f. The additional compressor 12 is configured to provide an air pressure level sufficient for satisfactory operation of the pneumatic de-icing system 100.

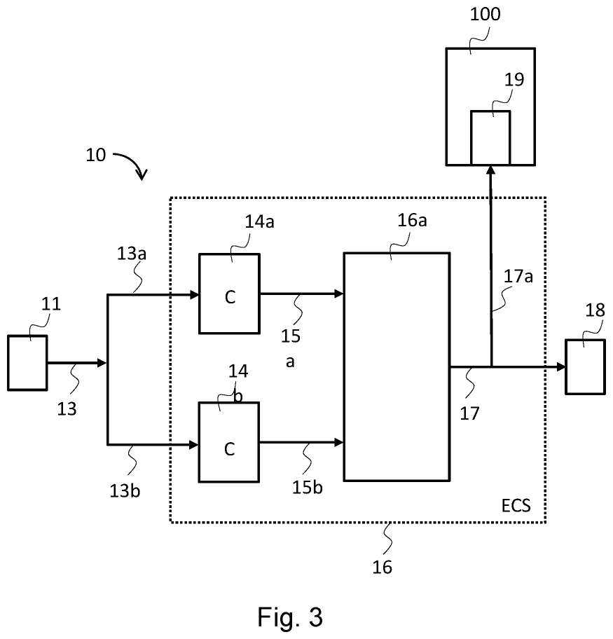

FIG. 3 schematically depicts an air supply system 10 for supplying air to a pneumatic de-icing assembly 100 of an aircraft, according to a second embodiment. All the elements schematically depicted in FIG. 3 are therefore arranged in the aircraft which comprises the pneumatic de-icing assembly 100. The pneumatic de-icing assembly 100 comprises an air inlet 19 connected to an air duct 17a. According to variants, the pneumatic de-icing assembly 100 comprises a plurality of air inlets that are similar to the air inlet 19 and that are connected to the air duct 17a.

The elements 11, 13, 13a, 13b, 14a, 14b, 15a, 15b, ECS 16, 16a, 18 and 19 are unchanged with respect to the first embodiment, apart from a drawing-in operation which is cleverly effected at the outlet of the air-conditioning system ECS 16 and which does not require adaptation of the scoop 11 and the first compression stage comprising the compressors 14a and 14b, this arrangement being particularly advantageous. Specifically, according to this configuration, the air drawn in for the operation of the de-icing system is the air which would have been ejected outside the aircraft in a configuration according to the prior art. The flow rate of air scooped in at the inlet of the aircraft therefore does not have to be increased. Drawing in air at the outlet of the air-conditioning system does not mean that the air is drawn in directly at the outlet, but from an element connected directly or indirectly to the outlet, such as, for example, a duct, or a bypass, or any element that can be used for the displacement of air from the air conditioning system ECS 16. In other words, according to this second embodiment, the air drawn in for the purpose of supplying the pneumatic de-icing assembly 100 is drawn in downstream of the air-conditioning system ECS 16 (and therefore upstream of the air-conditioning sub-assembly 16a) and upstream of the air outlet 18. There again, the term “downstream” in this case denotes a relative positioning towards the air outlet 18, and the term “upstream” in this case denotes a relative positioning towards the air inlet (or scoop) 11.

Advantageously, as the drawing-in operation upstream of the air-conditioning system ECS 16 does not require modification of the dimensioning of the air inlet 11, there is potentially no impact on the aerodynamic characteristics of the aircraft with respect to a configuration according to the prior art.

Since the air-conditioning system ECS 16 already conveys the air at a pressure close to that required, only an additional pressure may be necessary and the saving in energy is also increased with respect to the first embodiment.

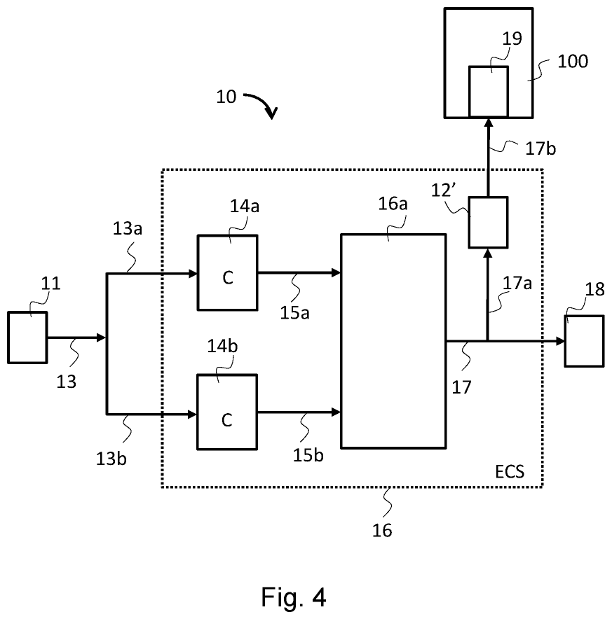

FIG. 4 depicts a variant of the second embodiment comprising an additional compressor 12′, the inlet of which is connected to the air duct 17a and the outlet of which is connected to the air inlet 19 of the pneumatic de-icing assembly 100 via an air duct 17b. The additional compressor 12′ is configured to provide any additional compression beneficial to the operation of the pneumatic de-icing system 100.

Advantageously, the first and second embodiments described make it possible to not have to draw air from the engines of the aircraft, this being particularly advantageous in the case of engine configurations which are referred to as “bleedless”, or in the case of electric motors.

The invention is not restricted to only the embodiments and examples described above, but more generally relates to any air supply system for supplying air to a pneumatic de-icing system for de-icing exterior surfaces of an aircraft, wherein air is drawn in downstream of the first air compression stage of the air-conditioning system of the aircraft or downstream of the air-conditioning system of the aircraft.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising:
an air supply system for a pneumatic de-icing assembly for de-icing surfaces of the aircraft, and
an air-conditioning system comprising:
at least one first supply compressor connected to a device for drawing in air outside the aircraft via at least one air duct,
the air supply system being configured such that an air supply inlet of said pneumatic de-icing assembly is connected to an outlet of said at least one first supply compressor, or to an outlet of said air-conditioning system via at least one air pipe provided for extracting air from volumes of the aircraft that are supplied with conditioned air, so as to draw air therein and to inflate or deflate an inflating boot of the pneumatic de-icing assembly using all or some of the air thus drawn in, and
an additional compressor configured to supply air to the air supply inlet of the de-icing assembly from said outlet of said first supply compressor or from said outlet of said air-conditioning system.

2. The aircraft according to claim 1,
wherein the air supply system comprises a second supply compressor connected to a device for drawing in air outside the aircraft via at least one air duct configured to supply at least said air-conditioning system, and
wherein said inlet of said de-icing assembly is further connected to an outlet of said second supply compressor.

3. A de-icing method for de-icing surfaces of an aircraft, executed in an air supply system for a pneumatic de-icing assembly for de-icing surfaces of the aircraft, the aircraft comprising an air-conditioning system, the air-conditioning system comprising at least one supply compressor connected to a device for drawing in air outside the aircraft via at least one air duct, the air supply system being arranged such that an air supply inlet of said pneumatic de-icing assembly is connected to an outlet of said at least one supply compressor or to an outlet of said air-conditioning system via at least one air pipe provided for extracting air from volumes of the aircraft that are supplied with conditioned air, the de-icing method comprising the following steps:
drawing in air at the outlet of a supply compressor configured to supply an air-conditioning system, or at the outlet of said air-conditioning system,
compressing the air drawn in by means of an additional compressor configured to supply air to the air supply inlet of the de-icing assembly from the outlet of said first supply compressor or from the outlet of the air-conditioning system, and thereafter
inflating or deflating an inflating boot using all or some of the drawn-in air.

4. An aircraft according to claim 1, configured to be propelled solely by electric motors.
